(19) United States
(12) Patent Application Publication
(10) Pub. No.: US 2026/0044649 A1
(43) Pub. Date: Feb. 12, 2026

(54) SYSTEMS AND METHODS FOR MODEL RECOVERY FROM REAL WORLD DATA

(71) Applicants: Ayan Banerjee, Gilbert, AZ (US); Sandeep Gupta, Phoenix, AZ (US)

(72) Inventors: Ayan Banerjee, Gilbert, AZ (US); Sandeep Gupta, Phoenix, AZ (US)

(73) Assignee: Arizona Board of Regents on Behalf of Arizona State University, Tempe, AZ (US)

(21) Appl. No.: 19/292,196

(22) Filed: Aug. 6, 2025

Related U.S. Application Data
(60) Provisional application No. 63/681,720, filed on Aug. 9, 2024.

(51) Int. Cl. G06F 30/27; G06F 17/13; G06F 111/10; G06N 3/0499; G06N 3/08

(52) U.S. Cl. CPC G06F 30/27; G06F 17/13; G06N 3/0499; G06N 3/08; G06F 2111/10

(57) ABSTRACT

A system and associated methods extend neural architectures such as liquid time constant neural network (LTC-NN) or continuous time recurrent neural networks (CT-RNN) or neural ordinary differential equations (NODE) to obtain advanced neural structures (LTC-NN-MR, CT-RNN-MR, NODE-MR) that can recover model coefficients of a dynamical system under low sampling rate conditions. The forward pass of these advanced neural structures has the same form as bilinear approximations of nonlinear dynamics. Measurements of real data can be used to convert the set of non-linear dynamics to an over-determined system of equations that are linear in terms of the model coefficients.

### CROSS REFERENCE TO RELATED APPLICATIONS

This is a non-provisional application that claims benefit to U.S. Provisional Patent Application Ser. No. 63/681,720 filed on Aug. 9, 2024, which is herein incorporated by reference in its entirety.

### FIELD

The present disclosure generally relates to recovering model coefficients of a dynamical system from observations sampled at low frequencies.

### BACKGROUND

In practical deployment, dynamical systems suffer from sampling constraints where data maybe sampled at or below Nyquist rate. Hence, model recovery (MR) techniques are required to provide good generalization performance (MR error on unseen traces) with low sampling rates. However, at sub-Nyquist rate, full information about model coefficients is not embedded in the traces, hence model recovery techniques should incorporate external knowledge such as sparsity structure of the non-linear dynamics to target reduction in model coefficient estimation error.

It is with these observations in mind, among others, that various aspects of the present disclosure were conceived and developed.

### BRIEF DESCRIPTION OF THE DRAWINGS

FIG. 1 is a graphical representation showing an effect of sampling frequency on model recovery generalization error for a Lotka Volterra system case study undertaken for development of a system outlined herein, where decreasing sampling frequency results in an increase in generalization error;

FIG. 2 is a simplified diagram showing implementation of neural architecture based model recovery system outlined herein;

FIGS. 3A-3D are a series of graphical representations showing comparison of SINDy-MPC with neural architecture for configuration FN by only varying sampling frequency to Nyquist rate, no implicit dynamics, with perturbation, and no input uncertainty; and

FIG. 4 is a simplified block diagram showing an example computing device that can be used to implement aspects of the systems and methods outlined herein, such as the model recovery system of FIG. 2.

Corresponding reference characters indicate corresponding elements among the view of the drawings. The headings used in the figures do not limit the scope of the claims.

### SUMMARY

A system for recovery of model coefficients of a dynamical system based on measurement data having a low sampling rate includes: a processor in communication with a memory, the memory including instructions executable by the processor to: access measurement data including a set of traces over time for a dynamical system, the set of traces being sampled at a sampling frequency; apply the measurement data as input to a neural architecture embodied at the processor, the neural architecture having a forward pass configuration that correlates with a bilinear approximation of a set of implicit dynamics of a control affine autonomous system; extract a set of hidden states associated with the measurement data by a plurality of nodes of the neural architecture; and transform, at a dense layer of the neural architecture, the set of hidden states into a set of model coefficient estimates and a set of input shift values that correlate with an over-determined system of equations descriptive of the set of implicit dynamics, the set of model coefficient estimates corresponding with a recovered model of the dynamical system.

The set of traces can include: a set of output measurements (Y) of the dynamical system over time including an initial condition value (Y(0)) of the set of output measurements; a set of system-initiated control inputs (U) applied by the dynamical system over time; and a set of user-initiated control inputs (Uex) applied to the dynamical system over time by a user.

The memory can further include instructions executable by the processor to: apply the set of model coefficient estimates, the set of input shift values, and one or more instances of the set of traces as input to an ordinary differential equation solver of the neural architecture resulting in a set of estimated output measurements (Yₑₛₜ); evaluate a loss between the set of estimated output measurements (Yₑₛₜ) and a set of output measurements (Y) of the set of traces; and iteratively update the set of model coefficient estimates to minimize the loss. The ordinary differential equation solver can incorporate a Runge Kutta integration method.

The sampling frequency can be less than a generalization boundary that correlates with a sampling frequency threshold where generalization error associated with a model learning method is higher than generalization error associated with a model recovery method. In some examples, the sampling frequency can be equal to a Nyquist rate.

The neural architecture can be a liquid time constant neural network (LTC-NN) architecture, a continuous time recurrent neural network (CT-RNN) architecture, or a neural ordinary differential equation-based (NODE) neural network architecture.

### DETAILED DESCRIPTION

Model recovery (MR) is the process of extracting coefficients of governing equations of a system from input output traces with two objectives: a) accurately reconstructing the input output traces, and b) reducing error in model coefficient estimation. Higher sampling rates increase model coefficient related information content in the traces improving the likelihood of MR techniques to optimize both objectives. At sampling rates above Nyquist rate, the information content saturates. At this point any MR technique that reduces reconstruction error by default also decreases model coefficient estimation error. In practical deployment, systems suffer from sampling constraints where data may be sampled at or below Nyquist rate. Hence, MR techniques are required to provide good generalized performance (MR error on unseen traces) with low sampling rates. However, at sub-Nyquist rate, full information about model coefficients is not embedded in the traces, hence model recovery techniques should incorporate external knowledge such as sparsity structure of the non-linear dynamics to target reduction in model coefficient estimation error.

The present disclosure includes the following contributions: i) analyze the effect of sampling frequency on Cramer Rao Lower Bound (CRLB), a fundamental lower bound on the best possible model coefficient extraction accuracy for any MR technique, ii) formally quantify the effect of sampling frequency on generalization performance of MR technique, iii) demonstrate that state-of-the-art sparse identification of non-linear dynamics (SINDY) based MR techniques have poor generalization error at low sampling rates, and iv) outline a liquid time constant neural network (LTC-NN) based architecture that can improve generalization performance under low sampling rates. The present disclosure demonstrates that automated differentiation property of LTC-NN nodes can maintain model structural constraints in between sample times and provides superior generalized model recovery performance than state-of-the-art non-linear MR techniques on simulation benchmarks and real world case studies.

To achieve this goal, it is important to understand and solve different challenges.

### 1 Introduction

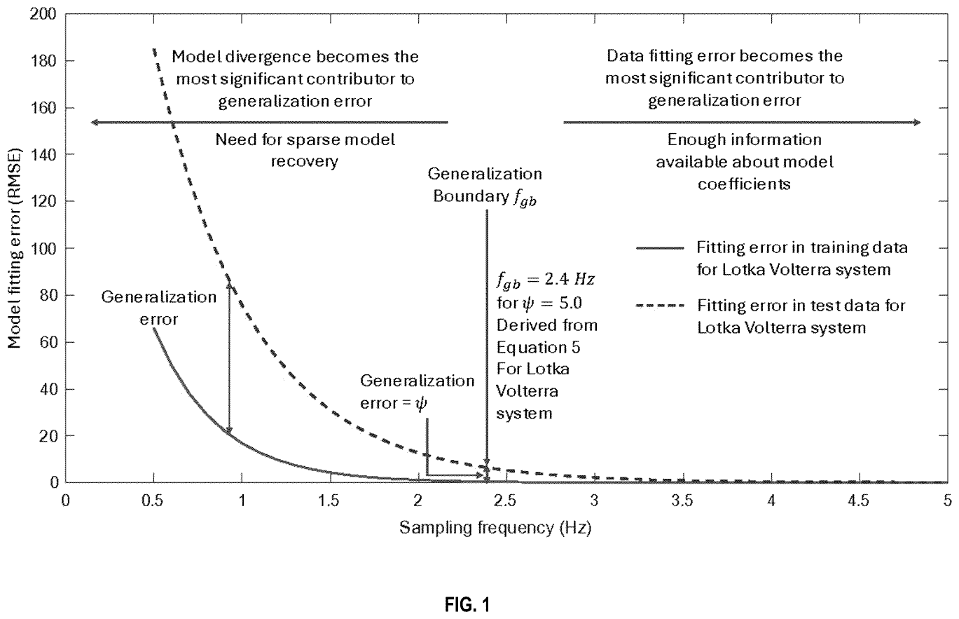

Model recovery (MR) is the process of extracting coefficients of the underlying non-linear dynamics of a dynamical system from time series data. It is a fundamental machine learning (ML) task that has widespread application in prediction, pattern recognition, and simulation. It is useful for several applications such as learning digital twins, safety analysis, anomaly detection, explainable artificial intelligence (AI) and prediction. MR techniques have two objectives: a) reducing error in model coefficient estimates, or model divergence error and b) reducing error between output samples and signal reconstructed using estimated model coefficients or reconstruction error. Like any ML task, MR techniques are evaluated based on their capacity to reduce generalization error, which is the difference in reconstruction error between seen training data and unseen test data (difference between dashed and solid curves in FIG. 1). It is well documented that as sampling frequency decreases, the generalization error of MR techniques degrade. The present disclosure focuses on the analysis and development of MR techniques to recover model coefficients from observations sampled at low frequencies.

Contribution 1: Effect of sampling frequency on the fundamental limits of MR generalization error—The model recovery problem is a subclass of the classical unbiased estimator extraction problem in estimation theory. As such, MR techniques generalization error is fundamentally limited by the Cramer Rao Lower Bound (CRLB), which establishes the best possible accuracy that can be obtained by any MR technique. The CRLB is inversely proportional to the information content (Fisher information) that the input output samples carry about the model coefficients. As sampling rate increases, the information content in the sampled traces also increase until sampling rate reaches the Nyquist rate. When data is sampled at Nyquist rate, it has enough information about the model coefficients such that MR techniques generalization error can be sufficiently reduced. Hence, sampling beyond the Nyquist rate adds very little information to the traces. Contribution 1 shows that CRLB reduces with increasing sampling frequency and asymptotically converges to a lower limit beyond Nyquist rate.

Contribution 2: Establishing novel bounds on sampling rate to limit MR generalization error—In real life deployment scenarios, sampling rate is often limited by several factors including cost of sensors, energy consumption, storage limitations, and physical limitations and privacy concerns in case of healthcare applications. Hence, often data is sampled at less than Nyquist rate as in the case of artificial pancreas medical system or space applications. As such enough information about model coefficients may not be available in sampled traces. In such scenarios, external knowledge about the coefficients such as sparsity in non-linear dynamical space is utilized to aid the MR technique in reducing generalization error. A model with n variables and M^{th} order non-linearity can utilize

$$( \begin{matrix}M + n \\ n\end{matrix} )$$

non-linear n terms to express observations. A model is sparse in the non-linear function space, if it includes only a few non-linear terms

$$p << ( \begin{matrix}M + n \\ n\end{matrix} ) .$$

to express the observations. Sparsity structure of a model is the set of non-linear terms used by the model. SINDY-MPC is the state-of-the-art technique that utilizes sparsity information for MR. The technique employs least square minimization with iterative sparsity information based coefficient selection. Contribution 2 establishes the fundamental limits on the MR generalization error reduction capacity of the sparsity assumption. The generalization boundary for a given dynamical system (ƒ_{gb} in FIG. 1) is derived such that if data is sampled at frequencies lower than ƒ_{gb} then the generalization error of SINDY-MPC will be greater than a specified error rate ψ.

Contribution 3: Demonstrating the effect of sampling rate reduction on generalization error of least square minimization based MR—The present disclosure evaluates the effect of sampling rate reduction on the generalization error of SINDY on four benchmark and one real world example in simulation and one real world example using real data. FIG. 1 shows an experiment on the Lotka Volterra dynamical system example (Nyquist rate=5 Hz), and plots the reconstruction error against sampling rate. Reconstruction error is computed as the root mean square error (RMSE) between output traces and the signal reconstructed using model coefficients recovered by SINDY-MPC. The solid curve is obtained by first executing SINDY-MPC on training data for sinusoidal inputs, reconstructing the output for sinusoidal inputs using model coefficients derived from SINDY-MPC and computing RMSE. It gives the training reconstruction error. The dashed curve is obtained by using the model coefficients obtained from training data, reconstructing outputs for a step input signal and computing RMSE. This gives the test reconstruction error. Both training and test error increases as sampling frequency is reduced. Moreover, the generalization error (gap between the two curves) also increases and goes beyond the limit ψ at sampling frequencies lower than the generalization boundary of 2.4 Hz.

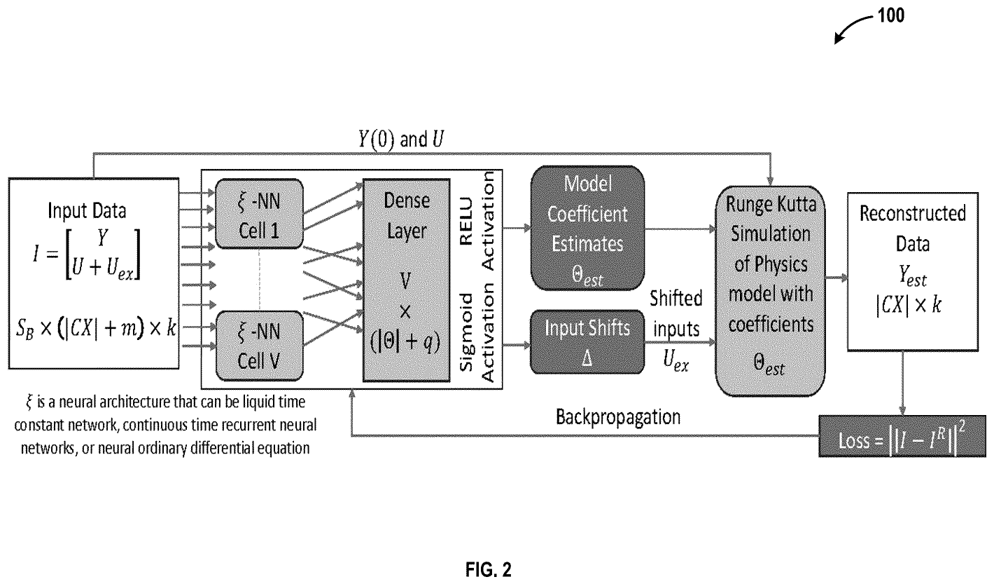

Contribution 4: Novel MR technique for low sampling rates: The present disclosure outlines a novel system and associated methods that extend neural architectures, such as liquid time constant neural network (LTC-NN) or continuous time recurrent neural networks (CT-RNN) or neural ordinary differential equations (NODE), to obtain advanced neural structures (LTC-NN-MR, CT-RNN-MR, NODE-MR) that can solve the model recovery problem for dynamical systems. The forward pass of these advanced neural structures has the same form as bilinear approximations of the nonlinear dynamics. The measurements of the real data can be used to convert the set of non-linear dynamics to an over-determined system of equations that are linear in terms of the model coefficients. However, an over-determined system of equation may have infinite solutions unless either some equations are rejected or are expressed as linear superposition of other equations. To search for a set of consistent equations to estimate model coefficient, a dense layer is utilized. The search process of the dense layer is guided by a loss function (ODE loss) that computes the mean square error between the reconstructed signal using an ODE solver and the ground truth measurements. FIG. 2 shows an example implementation of a system 100 outlined herein for model recovery.

The automated differentiation property of neural architectures such as LTC-NN, allows for model structure preservation in between samples and the ODE loss guides the search for the sparsest set of non-linear dynamics. This gives an unique opportunity to optimally explore the generalization curve.

TABLE 1
Related works in model recovery. High in column 2 means
greater than Nyquist rate, Low means at Nyquist rate.

| | | |
|---|---|---|
| Approach | Sampling | Assumptions |

Earlier approaches on model learning

| | | |
|---|---|---|
| Ho Kalman, Eigen system | Low | Linear system |
| Genetic Algorithm | High | Low dimensional nonlinear systems |

Recent Approaches on model recovery Class 1: Sparse Identification

| | | |
|---|---|---|
| SINDy | High | Known sparsity threshold and library |
| | | of polynomial functions |
| SINDy-MPC | High | Known sparsity threshold and library |
| | | of polynomial functions |
| E-SINDY | Low | Known sparsity threshold and library |
| | | of polynomial functions |

Recent Approaches on model recovery Class 2: Physics guided deep learning

| | | |
|---|---|---|
| Neural ODE + metriplectic | High | Known metriplectic structure |
| structure | | |
| PINNs + Sparse Regression | Low | Physics loss for original coefficients |
| Present Disclosure | Low | Black box ODE solver in the loss |

### 2 Related Works

Table 1 summarizes the recent works on MR. In the linear domain, system identification techniques such as Ho Kalman or Eigen system realization algorithm (ERA) attempt to fit a linear model to data. Such techniques cannot tackle non-linear dynamics, and do not preserve sparsity.

The seminal work on extracting non-linear model from data used stratified symbolic regression and genetic programming. This approach did not scale with dimension. Significant breakthrough was achieved through introduction of sparse identification of non-linear dynamics (SINDy). Subsequently SINDy has been extended to tackle control inputs in SINDy-MPC, however, it as shown in the present disclosure, it does not generalize well for low sampling frequencies.

Physics informed Neural Networks (PINN) utilize the concept of automatic differentiation to perform accurate forward and inverse analysis of non-linear physics models and has been used in many practical domains. However, such models are black box and cannot maintain sparse structure of the model. Recently, PINNs have been integrated with sparse regression to recover model coefficients. A major assumption in these approaches is the knowledge of physics loss for the original model coefficients. This is an impractical circular assumption since the original model coefficients are unknown in real world examples. Recently, with the advent of neural ordinary differential equation (NODE) structure there has been a class of approaches for forecasting while maintaining metriplectic structures, i.e., algebraic structures in models induced by laws of physics such as energy conservation, first and second law of thermodynamics. In such approaches sampling rates are unrealistically high.

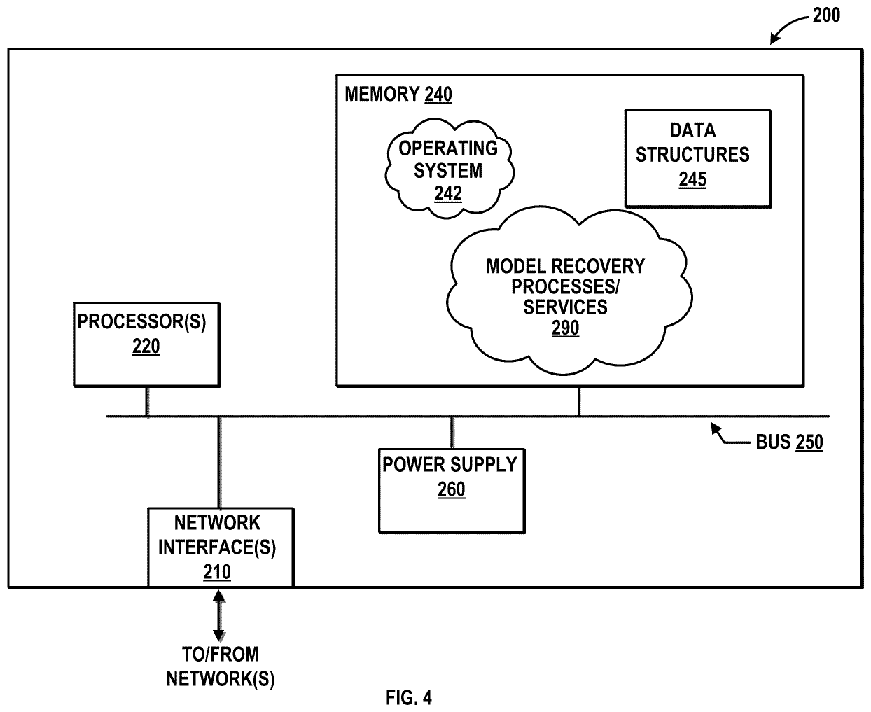

The present disclosure first provides a theoretical analysis of model recovery problem under low sampling frequencies and provides a solution (e.g., system 100 shown in FIG. 2 which can be implemented using a computing device such as computing device 200 of FIG. 4) that has better generalized performance than state of the art.

### 3 Preliminaries and Problem Statement

A control affine system whose n dimensional state space X={x₁ . . . xₙ}ϵ [symbol] ⁿ can be given by:

$$\frac{d X}{d t} = f ( X , Θ ) + g ( X , Θ ) ( U + {U}_{e x} ) , \qquad ( 1 )$$

where ƒ(X, Θ): [symbol] ₙ× [symbol] ^{p}→ [symbol] ⁿ is a model of the natural unperturbed dynamics of the physical (dynamical) system with human users in it (also called plant) that is perturbed by: a) an autonomous system U= [symbol] (X), where [symbol] : [symbol] ⁿ→ [symbol] ^{m} is a control function that generates the m dimensional actuation signals to the plant and U is a set of system-initiated control inputs applied by the dynamical system over time; and b) input from the human user (user-initiated control inputs) Uₑₓϵ [symbol] ^{m}. The total perturbation is denoted as U_{T}=U+Uₑₓ·g(X, Θ): [symbol] ⁿ× [symbol] ^{p}→ [symbol] ^{m}, expresses the effect of the input perturbation to the plant dynamics. Θ is a set of coefficients for the model of the autonomous system operation. In some scenarios, all state variables are measurable and hence measurements Y is same as X, in some other cases Y=βX, where β is a r×n matrix such that r<n. The control affine assumption enables decoupling the model recovery method into two sub-problems: a) recovering the unperturbed system ƒ(.); and b) recovering the input effects g(.). These sub-problems can be solved independently. Hence, to simplify the discussion, the present disclosure hence forth focuses on the sub-problem of recovering ƒ(.).

### 3.1 Model Recovery Problem Statement

Given a set [symbol] of traces of Y, U, Uₑₓ over time, sampled at frequency ƒₛ, the present disclosure demonstrates solving the model recovery problem to derive Θₑₛₜ such that ∥Θ−Θ∥²<ϵ, for some ϵ>0 error metric. However, note that the original Θ is unknown and cannot be used in the solution of the problem. Hence, the estimated model coefficients Θₑₛₜ has to be utilized to first derive an estimated trace Yₑₛₜ, and then ∥Yₑₛₜ−Y∥² can be used as objective function.

### 3.2 Cramer Rao Lower Bound

In estimation theory, given N samples of data X(tᵢ), i ϵ{1 . . . N} sampled at uniform rate/frequency ƒₛ at times t₁ . . . t_{N}, tᵢ−tᵢ₋₁=1/ƒₛ∀iϵ{1 . . . N}, the task is to derive the parameters Θ that defines the function ƒ(X, Θ) and g(X, Θ) that generated X(tᵢ).

Cramer Rao bound provides the fundamental limits of error for estimation methods. It states that the variance of the estimated model coefficients var(\hat{Θ}) from an unbiased estimator satisfies the following inequality—

$$var ( \hat{Θ} ) \geq \frac{1}{I ( Θ )} , such that I ( Θ ) = - \frac{1}{{σ}^{2}} {\sum }_{i = 1}^{N} {max}_{j ∈ \{ 1 … p \}} E ( \frac{{\partial }^{2} log ( X ( {t}_{i} ) )}{\partial {θ}_{j}^{2}} ) , \qquad ( 2 )$$

where I(Θ) is the Fisher information, and E(.) denotes expected value.

Fisher information is a fundamental property of the function ƒ or g which is obtained by computing the Jacobian matrix with respect to Θ. A loose lower bound only considers the diagonal elements of the Jacobian matrix, where Fisher information and CRLB for unbiased estimator are given by Equation 2. Here—is the standard deviation of noise in the data. The above equation is obtained by taking the general form of Fisher information for Gaussian noise in data described in Handel et al. (P. Handel, “Properties of the IEEE-STD-1057 four-parameter sine wave fit algorithm,” in IEEE Transactions on Instrumentation and Measurement, vol. 49, no. 6, pp. 1189-1193, December 2000, doi: 10.1109/19.893254.).

### 3.3 Nyquist Sampling Rate

Given the power spectral representation of the state variables of a dynamical system, the Nyquist rate is twice the dominant frequency. The Nyquist-Shannon theorem states that a function ƒ(t) can be exactly determined if it is sampled at Nyquist rate.

### 3.4 Reduction of MR to Least Square Minimization SINDy-MPC

Given N samples of data, at sampling frequency

$${f}_{r} = \frac{1}{τ}$$

the recovery problem can be reduced to solving the following set of linear equations:

$$[ \begin{matrix}\frac{dX}{dt} ( τ ) \\ \frac{dX}{dt} ( 2 τ ) \\ ⋮ \\ \frac{dX}{dt} ( N τ )\end{matrix} ] = [ \begin{matrix}ζ ( X ( τ ) , 0 ) & ζ ( X ( τ ) , 1 ) & … & ζ ( X ( τ ) , H ) \\ ζ ( X ( 2 τ ) , 0 ) & ζ ( X ( 2 τ ) , 1 ) & … & ζ ( X ( 2 τ ) , H ) \\ ⋮ & ⋮ & ⋱ & ⋮ \\ ζ ( X ( N τ ) , 0 ) & ζ ( X ( N τ ) , 1 ) & … & ζ ( X ( N τ ) , H )\end{matrix} ] \times [ \begin{matrix}{θ}_{0} \\ {θ}_{1} \\ ⋮ \\ {θ}_{H}\end{matrix} ] , \qquad ( 3 )$$

where

$$H = ( \begin{matrix}M + n \\ n\end{matrix} ) ,$$

and ζ(X(Kτ), i) is the i^{th} term in the bilinear expansion of ƒ(X) at the time sample t=kτ. For sparse identification, majority of the Θⱼ≈0, jϵ{1 . . . H} with only p significant elements Θ=[Θ₁ . . . Θₚ]. As such, N>>p, making Eqn. 3 an over-determined set of linear equations with no consistent solution. A solution method is least squares minimization, to recover Θₑₛₜ that minimizes e_{T}=∥Yₑₛₜ−Y∥².

SINDy-MPC solves the least square minimization problem using the sequential threshold ridge regression (STRidge) algorithm. This method iteratively selects dominant candidate from a library of high dimensional nonlinear functions. The sparsity was achieved through iteratively removing non-linear components utilizing hard thresholds on the derived model coefficients (manual configuration parameter).

### 4 Theoretical Contributions

This section first gives the closed form CRLB as a function of sampling frequency, and discusses the effect of sampling on model recovery accuracy, as well as key theoretical properties of neural architectures with automated differentiation that make them an ideal choice for MR.

### 4.1 CRLB as a Function of Sampling Frequency

Using Euler integration of ƒ(X, Θ), the diagonal term of the Jacobian of X(t) can be represented using Equation 4 (see also section 8-A).

$$\frac{{\partial }^{2} X ( {t}_{i} )}{\partial {θ}_{k}^{2}} = {\sum }_{j = 1}^{i} \frac{1}{{f}_{s}} \frac{{\partial }^{2} f ( X ( {t}_{i} ) , Θ )}{\partial {θ}_{k}^{2}} \qquad ( 4 )$$

Fisher information can be represented using Equation 5 (see also section 8-A).

$$I ( Θ ) \leq \frac{1}{{σ}^{2}} {\sum }_{i = 1}^{N} {\sum }_{k = 1}^{{Tf}_{s}} \frac{k}{{f}_{s}} E ( \frac{{f}_{max}^{″}}{X ( {t}_{i} )} ) , where {f}_{max}^{″} = {max}_{{θ}_{j} ∈ Θ} \frac{{\partial }^{2} f ( X ( {t}_{i} , Θ ) )}{\partial {θ}_{j}^{2}} , \qquad ( 5 )$$

where T is the time horizon of data. Equation 5 shows that Fisher information in each sample at time tᵢ decreases with increasing frequency. However, as number of samples increase, the overall summation increases. Hence at low frequencies, increasing sampling frequency may increase the Fisher information, however beyond Nyquist rate, the quantity

$$\frac{1}{{f}_{s}} E ( \frac{{f}_{max}^{″}}{X ( {t}_{i} )} )$$

becomes negligible and max_has no impact on I(Θ). This shows that the CRLB which is inverse of I(Θ) initially decreases with sampling frequency but asymptotically converges to a settling point

$${lim}_{{f}_{s} \to ∞} \frac{1}{{f}_{s}} E ( \frac{{f}_{max}^{″}}{X ( {t}_{i} )} ) .$$

### 4.2 Effect of Frequency on Model Recovery Error

Assume that the least square minimization problem in Eqn. 3 is solved with a maximum error of ψ:e_{T}≤ψ. This indicates that given two consecutive samples of measurements Y (as Y(kτ) and Y((k+1)τ)) the following inequality is defined:

$${‖ Y ( k τ ) - {Y}_{est} ( k τ ) ‖}^{2} \leq \frac{τψ}{T} , and {‖ Y ( ( k + 1 ) τ ) - {Y}_{est} ( ( k + 1 ) τ ) ‖}^{2} \leq \frac{τψ}{T} . \qquad ( 6 )$$

Within the sampling time interval, any recovered model with the guarantee of ψ error can deviate from the original model. Given that in the present disclosure is primarily directed to sparse models, the deviation can be characterized as a deviation in model coefficients Θ using Eqn. 3. Hence, in each time t in between samples, the error in any unseen time t, in other words generalization error can be expressed as:

$${g}_{e} ( t ) = {‖ {{\int }_{k τ}}^{t} [ f ( X ( k τ ) , Θ ) - f ( X ( k τ ) , {Θ}_{est} ) ] dt ‖}^{2} , t ∈ [ k τ , ( k + 1 ) τ ] \qquad ( 7 )$$

subjected to the constraints that

$${g}_{e} ( t ) \leq \frac{τψ}{T}$$

for t=kτ and t=(k+1)τ.

Considering the worst case difference in ground truth and estimated model coefficients, an upper bound of this generalization error subjected to the constraints in Eqn. 6 is derived as follows:

$${g}_{e}^{max} \leq {\underbrace{\sqrt{\begin{matrix}\frac{1}{N} {\sum }_{i = 1}^{N} {sup}_{{Θ}_{est} , t ∈ [ \frac{i}{{f}_{r}} , \frac{i + 1}{{f}_{r}} ]} f ( X ( t ) , {Θ}_{est} ) - \\ {inf}_{{Θ}_{est} , t ∈ [ \frac{i}{{f}_{r}} , \frac{i + 1}{{f}_{r}} ]} f ( X ( t ) , {Θ}_{est} )\end{matrix}}}}_{model divergence} + {\underbrace{{f}_{r} ψ}}_{data fit error} \qquad ( 8 )$$

Equation 8 is obtained pursuing residual analysis of Runge Kutta integration method.

### 4.3 The Generalization Boundary

Equation 8 describes a trade-off between two objectives: a) accurate data fitting, and b) accurate recovery of the model coefficients. At higher sampling frequencies, the model divergence term is insignificant. This suggests that if model recovery techniques solely focus on fitting the data, then it is highly probable that it will also find the right underlying dynamics. On the other hand, at low frequencies the model divergence term takes precedence over data fitting error. This indicates that at low frequencies the model recovery technique needs to focus on accurate model coefficient extraction, which in turn automatically guarantees good accuracy in data fitting.

This explores the classical trade-off between model learning, the process of data fitting and model recovery. Model learning may not utilize the knowledge of sparsity of the underlying equations and can be a general machine learning architecture that requires less resources to fit the data. On the other hand model recovery require the knowledge of sparsity. Often such knowledge is not available in real life deployments. Equation 8 defines a critical frequency termed as generalization boundary, ƒ_{gb}.

$${f}_{gb} = \frac{\sqrt{\frac{1}{N} {\sum }_{i = 1}^{N} {sup}_{{Θ}_{est} , t ∈ [ \frac{i}{{f}_{r}} , \frac{i + 1}{{f}_{r}} ]} f ( X ( t ) , {Θ}_{est} ) - {inf}_{{Θ}_{est} , t ∈ [ \frac{i}{{f}_{r}} , \frac{i + 1}{{f}_{r}} ]} f ( X ( t ) , {Θ}_{est} )}}{ψ} \qquad ( 9 )$$

If data is sampled beyond the generalization boundary then model learning and model recovery produce equivalent generalization performance. However, if data cannot be sampled beyond this boundary, then model recovery produces better generalization than model learning.

### 4.4 Properties of Neural Architecture

The forward pass of liquid time constant neural network (LTC-NN) is:

$$\frac{dh ( t )}{dt} = - \frac{h ( t )}{\frac{ρ}{1 + ρ {f}_{NN} ( h ( t ) , I ( t ) , t , ω )}} + {f}_{NN} ( h ( t ) , I ( t ) , t , ω ) ( A ) . \qquad ( 10 )$$

where h(t) is one hidden state of the LTC-NN, ρ is a time constant parameter, required to assist any autonomous system to reach equilibrium state. As such, existence of the

$$- h ( t ) / ( \frac{ρ}{1 + ρ {f}_{NN} ( h ( t ) , I ( t ) , t , ω )} )$$

term indicates an input dependent ρ time constant that matches the control affine dynamics of the autonomous system. ƒ_{NN} is the forward pass and is a function of the hidden states, I(t) is the input to the LTC-NN, ω and A are the parameters of the LTC-NN architecture.

Remark 1. The forward pass of an LTC-NN architecture generates a set of implicit physical dynamics that are equivalent to a bilinear approximations of the control affine autonomous system in Eqn. 1.

Remark 2. The inflated set of implicit dynamics modeled by LTC-NN induces an over-determined set of equations in the coefficients of the bilinear approximation of control affine model.

LTC-NN based MR technique. The system 100 outlined herein (FIG. 2) extends neural architectures such as liquid time constant neural network (LTC-NN) or continuous time recurrent neural networks (CT-RNN) or neural ordinary differential equations (NODE) to obtain advanced neural structures (LTC-NN-MR, CT-RNN-MR, NODE-MR) that can solve the model recovery problem. The forward pass of these advanced neural structures has the same form as bilinear approximations of the implicit dynamics in Eqn. 1 and hence can search through the space of implicit dynamics. The measurements of Y, can be used to convert the set of implicit dynamics to an over-determined system of equations that are linear in terms of the model coefficients. However, an over-determined system of equation may have no solution unless either some equations are rejected or are expressed as linear superposition of other equations. To search for a set of consistent equations to estimate model coefficient, a dense layer is utilized. The search process of the dense layer is guided by a loss function (ODE loss) that computes the mean square error between the estimated Yₑₛₜ using an ODE solver SOLVE(Y(0), Θ, U+Uₑₓ) and the ground truth measurements of Y.

### 5 Implementation

The advanced neural architectures for model recovery (ξ-MR, where ξ is either LTC-NN, CT-RNN, or NODE) (FIG. 2) is implemented by extending the base code (for LTC-NN, Hasani et al. (Hasani, R., Lechner, M., Amini, A., Rus, D., Grosu, R.: Liquid time-constant networks. In: Proceedings of the AAAI Conference on Artificial Intelligence. vol. 35, pp. 7657-7666 (2021)). For each example, the training data extracted includes temporal traces of Y, U and Ex. Y is sampled at a sampling rate that is greater than or equal to the Nyquist rate for the application, and U has the same sampling rate as Y. Ex is a set of tuples denoting

$${U}_{ex}^{i}$$

values at time

$${t}_{e x}^{i} .$$

Ex is transformed into a signal at the same sampling frequency as Y by keeping

$${U}_{e x}^{i}$$

at times

$${t}_{e x}^{i}$$

and appending 0s at all other times. The resulting training data is then divided into batches of size S_{B}. This forms a 3D tensor of size S_{B}×|Y|+m×k.

Each batch is passed through the network with V nodes, resulting in V hidden states. A dense layer is then employed to transform this V hidden states into p=|Θ| model coefficient estimates and q input shift values. The dense layer is a multi-layer perceptron with ReLU activation function for the model coefficient estimate nodes and sigmoid activation function for input shift values. The input shift values are used to shift the external input vector. The shifted inputs, the model coefficient estimates, and the initial value Y(0) is passed through an ODE solver, that solves the control affine model in Eqn. 1 with the coefficients Θₑₛₜ, initial conditions Y(0) and inputs U and Uₑₓ. The Runge Kutta integration method is used in the ODE solver, which gives Yₑₛₜ. The backpropagation of the network is performed using the network loss appended with ODE loss, which is the mean square error between the original trace Y and estimated trace Yₑₛₜ.

### 6 Evaluation

Evaluation results in this section of the present disclosure show two types of examples: a) simulation benchmarks obtained from SINDy-MPC; and b) real world data available for the example of automated insulin delivery (AID) systems for Type 1 Diabetes (T1D).

### 6.1 Benchmark Examples

Table 2 lists all examples.

Automated Insulin Delivery System. In the AID system, the glucose insulin dynamics is given by the Bergman Minimal Model (BMM):

$$i ( \dot{t} ) = - n i ( t ) + {p}_{4} {u}_{1} ( t ) , {i}_{s} ( \dot{t} ) = - {p}_{1} {i}_{s} ( t ) + {p}_{2} ( i ( t ) - {i}_{b} ) \qquad ( 11 )$$

$$\dot{G ( t )} = - {i}_{s} ( t ) {G}_{b} - p 3 ( G ( t ) ) + u 2 ( t ) / {V}_{0} I , \qquad ( 12 )$$

The input vector U(t) includes the input insulin level u₁(t), which is derived using a self adaptive MPC controller like Tandem Control IQ. Uₑx represents the glucose appearance in the body u₂ for a meal. In the real world, users forget to report the exact timing of the meal and also make mistake in estimating the exact carbohydrate amount that they consumed. This error is modeled as input uncertainty in time and magnitude. The state vector X(t) includes the blood insulin level i, the interstitial insulin level is, and the BG level G. The measured vector Y=G since CGM measures only glucose. p₁, p₂, i_{b}, p₃, p₄, n, and 1/V₀I are all patient specific coefficients.

Real World Data. The LOIS-P dataset is used for the real world AID example, which includes 25 patients with pre-existing T1D for at least a year. All patients were enrolled before 17 weeks gestational age at three sites: Mayo Clinic, Rochester, Mount Sinai in New York City, and Sansum Diabetes Research Institute. On an average 24.7 weeks (±5.2) of Dexcom G6 CGM glucose at 5 mins interval and insulin pump data including insulin and meal intake data.

TABLE 2
Benchmark Examples.

| | | | Nyquist | | Max sampling | | No of co- |
|---|---|---|---|---|---|---|---|
| Example | Variables | Inputs | rate | | rate | | efficients |
| Simulation: Lotka Volterra | x₁, x₂ | 1 | 2.5 | Hz | 10 | Hz | 4 |
| Simulation: Chaotic Lorenz System | x₁, x₂, x₃ | 1 | 100 | Hz | 1000 | Hz | 4 |
| Simulation: F8 Crusader tracking | x₁, x₂, x₃ | 1 | 100 | Hz | 1000 | Hz | 20 |
| Simulation: Pathogenics attack | x₁, x₂, x₃ | 1 | 2.8 × 10⁻⁴ | | 5.6 × 10⁻⁴ | | 13 |
| | x₄, x₅ | | | | | | |
| Real world: Autmated Insulin Delivery | I_{S} G I | 2 | 0.0028 | Hz | 0.0033 | Hz | 9 |
| Simulation: AID | I_{S} G I | 2 | 0.0028 | Hz | 10 | Hz | 9 |

Simulation data. Benchmark example simulations use data from SINDy-MPC available on GitHub from Kaiser et al. (Kaiser, E., Kutz, J. N., Brunton, S. L.: Sparse identification of nonlinear dynamics for model predictive control in the low-data limit. Proceedings of the Royal Society A 474(2219), 20180335 (2018)).

Simulation data for AID: 14 traces of glucose insulin dynamics were considered, each of which including 200 samples (16 hrs). In each trace, meal ingestion time was varied from [t=15 mins to t=400 min] with carbohydrate value randomly sampled from the range [0 g, 28 g] for each meal, and bolus insulin delivery was sampled from the set [0 U, 40 U]. The traces were generated using the T1D simulator. Two sampling frequencies are tested: i) 10 Hz; and ii) real world CGM sampling rate of every 5 mins (Table 2).

### 6.2 Baseline Techniques

Evaluation presented herein compares results obtained using the following baseline strategies:

SINDy-MPC: This baseline (Kaiser et al.) is used to show that reducing sampling rate to a minimum of Nyquist rate, causes significant degradation of performance for SINDY class of approaches. However, it has little effect on neural architectures such as the LTC-NN-MR approach.

NODE-MR: This baseline is the seminal work on neural architecture (see Lee et al. (Lee, K., Trask, N., Stinis, P.: Machine learning structure preserving brackets for forecasting irreversible processes. In: Ranzato, M., Beygelzimer, A., Dauphin, Y, Liang, P., Vaughan, J. W. (eds.) Advances in Neural Information Processing Systems. vol. 34, pp. 5696-5707. Curran Associates, Inc. (2021)).

CT-RNN-MR: This baseline strategy has an input independent time constant factor in its forward pass and is similar to the unperturbed component.

LTC-RNN-MR: This is the system 100 outlined herein with respect to FIG. 2.

### 6.3 Evaluation Experiments and Metrics of Success

For each evaluation experiment, two metrics are employed:

Root mean square error in model coefficients (RMSE_{Θ}): Given the estimated model coefficients Θₑₛₜ for any technique RMSE_{Θ} is computed as in Eqn. 13:

$$\begin{matrix}{RMSE}_{Θ} = \sqrt{\frac{1}{p} {\sum }_{j = 1 … p} {( {Θ}_{est}^{j} - {Θ}^{j} )}^{2}} , and \\ {RMSE}_{Y} = \frac{1}{n} {\sum }_{l = 1 … n} \sqrt{\frac{1}{k} \times {\sum }_{j = 1 … k} {( {Y}_{est}^{l} ( j ) - {Y}^{l} ( j ) )}^{2}}\end{matrix} \qquad ( 13 )$$

Root mean square error in signal (RMSE_{Y}): Given the estimation of the measured variables Yₑₛₜ for any technique RMSE_{Y} is computed as outlined in Eq. 13.

All compared techniques identify sparsity preserving dynamics. Evaluation starts with a configuration Φ₀ that has high sampling rates shown in column 7 of Table 2, has no implicit dynamics, has input perturbation, and having uncertainty in input magnitude (no temporal uncertainty). To determine the effect of sampling rate, the sampling rate of Φ₀ is varied from the rate used in the simulation data to the Nyquist rate (Table 2), and the resulting variation of RMSE_{Φ} and RMSE_{Y} is analyzed. The configuration with Nyquist sampling rate is denoted as Φ_{N}.

Real world experiment: Evaluation compares the three neural architectures for their performance in modeling real data. For this experiment, the ground truth model coefficients Θ are unknown, and performance of the techniques are compared using RMSE_{Y}.

### 6.4 Training and Validation Method

SINDy-MPC: Evaluation was conducted following the same training method as used in SINDy-MPC and as reflected in the code accessed from GitHub (Kaiser et al.). In the experiments, with ϕ_{N}, the dt variable in the “getTrainingData.m” from the minimum value corresponding to maximum frequency in each example (Table 2) was altered to the Nyquist rate. The Nyquist rate is obtained by computing the power spectral density of the signals sampled at the highest frequency. The frequency freq₉₀ at which the cumulative power density reaches 90% of the maximum level was then extracted. The Nyquist rate is two times freq₉₀. The dt is updated to obtain four frequency points with the maximum value of dt corresponding to the Nyquist rate. For each example, the training and validation implemented in Kaiser et al. is employed to generate the RMSE_{Y} and RMSE_{Θ} for SINDy-MPC.

Neural Architectures: Batch training was utilized for each example. For each example, the same simulation data as SINDy-MPC was taken and the traces were divided into 48 instances of training and 16 instances of testing, each trace including at least k=200 samples. The training instances were passed to the neural architectures with a batch size S_{B}=32. The RMSE_{Y} and RMSE_{Θ} are reported on the test data.

### 6.5 Results

This section first compares SINDy-MPC and all neural architecture on the benchmark examples in Kaiser et al.

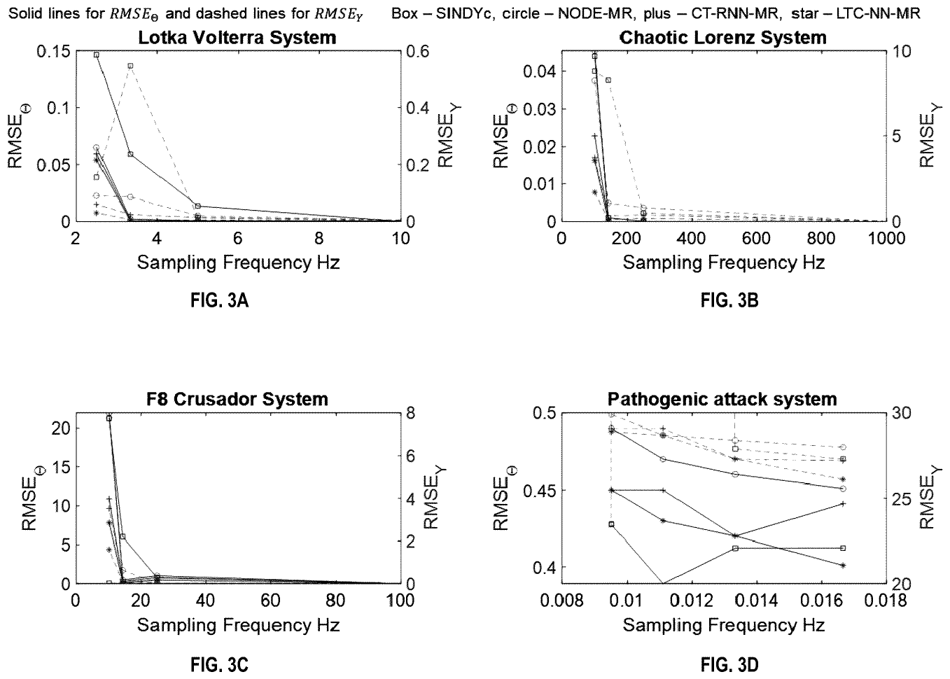

Benchmark examples effect of sampling rate: As seen from FIGS. 3A-3D, at sampling rates nearly four times Nyquist rate, all techniques give similar RMSE_{Θ} and RMSE_{Y}. As sampling rates are increased every technique has degradation in both the performance metrics. However, SINDy-MPC is most affected by the change in sampling frequency. All neural architectures perform better than SINDy-MPC, with LTC-NN-MR showing the best performance. The primary reason for such a result is the fact that as data is sampled less frequently, the set of potential models that fit the data increases. While SINDy-MPC imposes the constraint of sparsity, the neural architectures impose further constraints on top of sparsity through their structure. The most restrictive constraint is the input-dependent time constant of LTC-NN-MR, and hence LTC-NN-MR performs the best. CT-RNN-MR has the next most stringent constraint while NODE has the least restrictive constraint among the neural architectures. In all examples except for the pathogenics attack, similar trends can be seen for RMSE_{Θ} where LTC-NN-MR outperforms all neural architectures, which in turn outperforms SINDy-MPC at Nyquist sampling rate. For the pathogenics attack example, an interesting occurrence is observed, where at Nyquist rate, SINDy-MPC has the best performance in both the metrics. However, at the next sampling frequency SINDy-MPC has a very high RMSE_{Y} for a slight change in RMSE_{Θ}. All neural architectures differed from this trend and both RMSE_{Θ} and RMSE_{Y} improved. The main reason for this is that SINDy-MPC violates the sparsity constraint. On closer look it was found that SINDy-MPC obtained a totally different physical model of the plant. A hint of this behavior is also seen in the LOTKA-Volterra and F8 Crusader example, where decreasing sampling frequency to Nyquist rate reduced RMSE_{Y} but increased RMSE_{Θ}. Similarly, it was observed that SINDy-MPC compensated for loss in RMSE_{Θ} performance by adding extra non-linear terms to reduce RMSE_{Y}. From the results, such behavior was not observed for the neural architectures. One main reason can be because ODE Solver at the loss function guides the exploration of the dynamics.

Generalization boundary: The generalization boundaries for a generalization error of 5% difference between train and test errors is derived from the data in FIGS. 3A-3D and equation 9. From the data in FIG. 3A (Lotka Volterra) ƒ_{gb} is 2.4 Hz, for FIG. 3B (Chaotic Lorenz) ƒ_{gb} is 250 Hz, for FIG. 3C (F8 Crusader system) ƒ_{gb} is 17.4 Hz, for FIG. 3D (the pathogenic attack system) ƒ_{gb} is 0.0117 Hz. It was observed that computation of generalization boundaries from Equation 9 are 2.12 Hz, 244 Hz, 18.1 Hz, and 0.015 Hz respectively for each of the examples. On an average, Equation 9 disagrees with FIGS. 3A-3D by a normalized RMSE of 1.97%.

TABLE 3
Comparison of baseline techniques for AID simulation
example with no implicit dynamics.

| | | | | | without | |
|---|---|---|---|---|---|---|
| | fₛ = 10 Hz | | fₛ = 0.0033 Hz | | input shifts | |
| Approach | RMSE_{Y} | RMSE_{Θ} | RMSE_{Y} | RMSE_{Θ} | RMSE_{Y} | RMSE_{Θ} |
| SINDy-MPC | 0.004 | 0.342 | 14.5 | 2.44 | 101.6 | 22.3 |
| LTC-NN-MR | 0.003 | 0.213 | 0.31 | 0.45 | 31.3 | 14.1 |
| CT-RNN-MR | 0.007 | 0.311 | 0.76 | 0.8 | 43.2 | 17.8 |
| NODE-MR | 0.012 | 0.56 | 1.3 | 1.1 | 77.4 | 23.6 |

fₛ is sampling frequency

Automated Insulin Delivery Example Simulation Examples: In Table 3, SINDy-MPC did not have any temporal uncertainty for meal inputs. The neural architectures had temporal uncertainty at meal inputs and also used input shifts in the architecture. However, for the last column, the input shift from neural architectures are removed and SINDy-MPC is also evaluated for uncertainty at meal input. All techniques perform well for model recovery from simulation data at 10 Hz sampling rate. SINDy-MPC shows excellent RMSE_{Y} but poor RMSE_{Θ}. The neural architectures perform similar to SINDy-MPC at such high sampling frequency. However, when the sampling rate is reduced to Nyquist rate, all methods have performance degradation, with SINDy-MPC suffering the most. LTC-NN-MR still performs better than the baseline techniques. When input shifts are removed, all techniques suffered significant reduction in performance.

Real World Example Input Uncertainty: Table 4 shows the performance of the neural architectures on real data. Without exploring temporal uncertainty of inputs, the best RMSE_{Y} obtained for LTC-NN-MR was 26.1. Note that the state of art CGM prediction mechanism for 30 mins ahead prediction has an RMSE of 11.1. With input shift enabled in the architecture, significant improvement in RMSE_{Y} is observed for each neural architectures. For LTC-NN-MR an RMSE_{Y} of 3.03 is obtained, which is significantly better than forecasting mechanisms.

TABLE 4
RMSE_{Y} comparison for AID real world example with sampled
data, control + human perturbed system, sparse
dynamics, implicit dynamics, and input uncertainty.

| | |
|---|---|
| Approach | no input shifts with input shifts |

| | | |
|---|---|---|
| NODE-MR | 45.6 | 8.7 |
| CT-RNN-MR | 32.3 | 6.8 |
| LTC-NN-MR | 26.1 | 3.03 |

### 7 Conclusions

This disclosure first outlines a closed form expression for the variation of CRLB with respect to frequency and shows that the lower bound decreases with increasing sampling frequency finally reaching a settling point. Further, the present disclosure provides a fundamental sampling boundary below which sparsity information does not improve generalization error. The generalization boundary is useful in practical applications to design model fitting in presence of sampling and computational resource constraints. The present disclosure also outlines LTC-NN-MR (the system 100 shown in FIG. 2) which implements a novel method for model recovery that improves generalization error at sampling frequencies lower than the generalization boundary. With the sparsity information, the novel liquid time constant neural network-based (LTC-NN) approach outperforms state-of-the-art model recovery techniques w.r.t model fitting accuracy in both simulation and real world case studies. Results show that LTC-NN-MR is robust against human reporting errors, and presence of implicit dynamics and provides a practical solution to a fundamental problem of generalized model recovery under sampling constraints.

### 8 Additional Information

### 8-A Proof of Cramer Rao Lower Bound

X(tᵢ) can be expanded as follows:

$$X ( {t}_{i} ) = X ( {t}_{i - 1} ) + f ( X ( {t}_{i - 1} ) ) / {f}_{s} \qquad ( 14 )$$

$$X ( {t}_{i - 1} ) = X ( {t}_{i - 2} ) + f ( X ( {t}_{i - 2} ) ) / {f}_{s} \qquad ( 15 )$$

$$⋮ \qquad ( 16 )$$

$$X ( {t}_{1} ) = X ( {t}_{0} ) + f ( X ( {t}_{0} ) ) / {f}_{s} \qquad ( 17 )$$

Adding all equations:

$$X ( {t}_{i} ) = X ( {t}_{0} ) + {\sum }_{j = 1}^{i} f ( X ( {t}_{i} ) ) / {f}_{s} \qquad ( 18 )$$

Double differentiation of Equation 18 results in Equation 4 discussed in section 4.1 above.

Equation 5 in section 4.1 can be obtained by replacing Equation 18 in Equation 2 and following the steps outlined in Vaidyanathan et al. (Vaidyanathan, P.: Generalizations of the sampling theorem: Seven decades after nyquist. IEEE Transactions on Circuits and Systems I: Fundamental Theory and Applications 48(9), 1094-1109 (2001)).

### 8-B Supporting Arguments for LTC-NN Remarks

Remark 3. The forward pass of an LTC-NN architecture generates a set of implicit physical dynamics that are equivalent to a bilinear approximations of the control affine autonomous system in Eqn. 1.

Algebraic manipulation of the forward pass of LTC-NN architecture gives the structure of Eqn. 19 which allows an input dependent time constant

$$\frac{ρ}{1 + ρ {f}_{N N} ( h ( t ) , I ( t ) , t , ω )} . \qquad ( 19 )$$

$$\frac{d h ( t )}{d t} = - \frac{h ( t )}{\frac{ρ}{1 + ρ {f}_{N N} ( h ( t ) , I ( t ) , t , ω )}} + {f}_{N N} ( h ( t ) , I ( t ) , t , ω ) ( A ) .$$

The stability criteria for any autonomous system requires the control affine model to have a time constant term as shown in Eqn. 20:

$$\frac{d X}{d t} = - X / ρ + {f}_{- ρ} ( X ) + g ( X ) {U}_{T} , \qquad ( 20 )$$

where ρ is the time constant of the system and ƒ_{-ρ}(.) is the unperturbed dynamics obtained by removing the time constant component from ƒ(.).

Assuming that the autonomous system is a dynamic causal system, the bilinear approximation of the control affine system in Eqn. 20 results in Eqn. 21.

$$\frac{d X}{d t} \approx - X / ρ + {f}_{- ρ} ( X ) + B X + C {U}_{T} + {\sum }_{j} {u}_{T}^{j} {D}^{j} X + H . \qquad ( 21 )$$

$$where B = \frac{\partial ( g ( X ) {U}_{T} )}{\partial X} , C = \frac{\partial ( g ( X ) {U}_{T} )}{\partial {U}_{T}} , {D}^{j} = \frac{{\partial }^{2} ( g ( X ) {U}_{T} )}{\partial X \partial {u}_{T}^{j}} ,$$

and H is a constant.

Rearranging Eqn. 21, the similar form as the LTC-NN forward pass in Eqn. 22 is obtained.

$$\frac{d X}{d t} \approx - \frac{X}{\frac{ρ}{1 + ρ ( B + {Σ}_{j} {u}_{T}^{j} {D}^{j} )}} + ( {f}_{- ρ} ( X ) + C {U}_{T} + H ) . \qquad ( 22 )$$

It is observed that Eqn. 22 is the same form as Eqn. 19 if the input to the LTC-NN I(t) is a concatenation of Y and U_{T}. The hidden layers of the LTC-NN model an inflated set of implicit dynamics which may include the unmeasured system variables of the physics model.

Remark 4. The inflated set of implicit dynamics modeled by LTC-NN induces an over-determined set of equations in the coefficients of the bilinear approximation of control affine model.

The training process of LTC-NN fixes weights and instantiates the hidden layer outputs. The values of the unmeasured variables in X is estimated by the hidden state in each training step utilizing the forward pass and learned LTC-NN weights w. Hence each forward pass provides an over-determined set of linear equations in the coefficients B, C, and D^{j}.

The original control affine model coefficients Θ are non-linear functions of the coefficients B, C, and D^{j}. The dense layer is best suited for exploring a large set of possible non-linear combinations of B, C, and D^{j} that express Θ. An over-determined system of equations is inconsistent and may be unsolvable. The dense layer guided by the ODE solver induced loss function (ODE Loss) learns a consistent set of linear equations in B, C, and D^{j} and also learns their non-linear combination to determine Θ.

### 8.C Implementation Details

For the neural architectures, implementations were based on the code-base available on GitHub (Hasani et al.). Here, a generic framework for LTC-NN, CT-RNN, and NODE is implemented using tensorflow 2.7.0. A custom loss function was developed that implements the Runge Kutta solution of the physical dynamics given a vector of model coefficients. The general training architecture presented in Hasani et al. with an ADAM optimizer was further employed. The framework can be instantiated with LTC-NN, CT-RNN and NODE core architecture through an input parameter.

### 8.D Lotka Volterra Model

The Lotka Volterra model has two variables x₁ and x₂ given by the following equations:

$${\dot{x}}_{1} = a {x}_{1} - b {x}_{1} {x}_{2} \qquad ( 23 )$$

$${\dot{x}}_{2} = - c {x}_{2} + d {x}_{1} {x}_{2} + u \qquad ( 24 )$$

$$a = 0. 5 , b = 0.025 , c = 0.5 , and d = 0.005$$

### 8.E Chaotic Lorenz System

The Chaotic Lorenz system is described in the following equations:

$${\dot{x}}_{1} = σ ( {x}_{2} - {x}_{1} ) + u \qquad ( 25 )$$

$${\dot{x}}_{2} = {x}_{1} ( ρ - {x}_{3} ) - {x}_{2} \qquad ( 26 )$$

$${\dot{x}}_{3} = {x}_{1} {x}_{2} - β {x}_{3} \qquad ( 27 )$$

$$σ = 10 , β = 8 / 3 , ρ = 28 .$$

### 8.F F8 Crusader System

The F8 Crusader system is given by:

$${\dot{x}}_{1} = - 0.877 {x}_{1} + {x}_{3} - 0.088 {x}_{1} {x}_{3} \qquad ( 28 )$$

$$+ 0.4 \; 7 {x}_{1}^{2} - 0.019 {x}_{2}^{2} - {x}_{1}^{2} {x}_{3} \qquad ( 29 )$$

$$+ 3.8 \; 46 {x}_{1}^{3} - 0.215 u + 0.28 {x}_{1}^{2} u \qquad ( 30 )$$

$$+ 0.4 \; 7 {x}_{1} {u}^{2} + 0.63 {u}^{3} \qquad ( 31 )$$

$${\dot{x}}_{2} = {x}_{3} \qquad ( 32 )$$

$${\dot{x}}_{3} = - 4.208 {x}_{1} - 0.396 {x}_{3} \qquad ( 33 )$$

$$- 0.4 \; 7 {x}_{1}^{2} - 3.564 {x}_{1}^{3} \qquad ( 34 )$$

$$- 20. 967 u + 6.265 {x}_{1}^{2} u \qquad ( 35 )$$

$$+ 46 {x}_{1} {u}^{2} + 61.1 {u}^{3} \qquad ( 36 )$$

### 8.G Pathogenic Attack System

The pathogenic attack system is given by:

$${\dot{x}}_{1} = λ - d {x}_{1} - β ( 1 - η u ) {x}_{1} {x}_{2} \qquad ( 37 )$$

$${\dot{x}}_{2} = β ( 1 - η u ) {x}_{1} {x}_{2} - a {x}_{2} - {p}_{1} {x}_{4} {x}_{2} - {p}_{2} {x}_{5} {x}_{2} \qquad ( 38 )$$

$${\dot{x}}_{3} = {c}_{2} {x}_{1} {x}_{2} {x}_{3} - {c}_{2} q {x}_{2} {x}_{3} - {b}_{2} {x}_{3} \qquad ( 39 )$$

$${\dot{x}}_{4} = {c}_{1} {x}_{2} {x}_{4} - {b}_{1} {x}_{4} \qquad ( 40 )$$

$${\dot{x}}_{5} = {c}_{2} q {x}_{2} {x}_{3} - h {x}_{5} , \qquad ( 41 )$$

$$with λ = 1 , d = 0.1 , β = 1 , a = 0.2 , {p}_{1} = 1 , {p}_{2} = 1 , {c}_{1} = 0.03 , {c}_{2} = 0.06 , {b}_{1} = 0.1 , {b}_{2} = 0.01 , q = 0.5 , h = 0.1 , and η = 0.9799 .$$

### 9 Computer-Implemented System

FIG. 4 is a schematic block diagram of an example computing device 200 that may be used with one or more embodiments described herein, e.g., implementing aspects of the system 100 shown in FIG. 2.

Computing device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, computing device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and associated methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes computing device 200 by, inter alia, invoking operations in support of software processes and/or services executing on the device. These software processes and/or services may include model recovery processes/services 290, which can include aspects of the methods discussed herein with respect to the system 100 of FIG. 2 and/or implementations of various modules described herein. Note that while model recovery processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the model recovery processes/services 290 is shown as a standalone process, those skilled in the art will appreciate that this process may be executed as a routine or module within other processes.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for recovery of a model of a dynamical system based on measurement data having a low sampling rate, comprising:
a processor in communication with a memory, the memory including instructions executable by the processor to:
access measurement data including a set of traces over time for a dynamical system, the set of traces being sampled at a minimum sampling frequency;
apply the measurement data as input to a neural network embodied at the processor, the neural network including an architecture having a forward pass configuration that correlates with a bilinear approximation of a set of implicit dynamics of the dynamical system, the neural network configured by the architecture to sample data less frequently near the minimum sampling frequency and impose an input-dependent time constraint on a set of potential models for the dynamical system;
extract a set of hidden states associated with the measurement data by a plurality of nodes of the neural network; and
transform, at a dense layer of the neural network, the set of hidden states into a set of model coefficient estimates and a set of input shift values that correlate with an over-determined system of equations descriptive of the set of implicit dynamics, the set of model coefficient estimates corresponding with a recovered model of the set of potential models for of the dynamical system.

2. The system of claim 1, the set of traces including:
a set of output measurements (Y) of the dynamical system over time including an initial condition value (Y(0)) of the set of output measurements;
a set of system-initiated control inputs (U) applied by the dynamical system over time; and
a set of user-initiated control inputs (Uₑₓ) applied to the dynamical system over time by a user.

3. The system of claim 1, the memory further including instructions executable by the processor to:
apply the set of model coefficient estimates, the set of input shift values, and one or more instances of the set of traces as input to an ordinary differential equation solver of the neural network resulting in a set of estimated output measurements (Yₑₛₜ); and
evaluate a loss between the set of estimated output measurements (Yₑₛₜ) and a set of output measurements (Y) of the set of traces.

4. The system of claim 3, the ordinary differential equation solver incorporating a Runge Kutta integration method.

5. The system of claim 3, the memory further including instructions executable by the processor to:
iteratively update the set of model coefficient estimates to minimize the loss.

6. The system of claim 1, the minimum sampling frequency being less than a generalization boundary that correlates with a sampling frequency threshold where generalization error associated with a model learning method is higher than generalization error associated with a model recovery method.

7. The system of claim 6, wherein the minimum sampling frequency is equal to a Nyquist rate.

8. The system of claim 1, the neural network being a liquid time constant neural network.

9. The system of claim 1, the neural network being a continuous time recurrent neural network.

10. The system of claim 1, the neural network being a neural ordinary differential equation-based neural network.
